(19) United States
(12) Patent Application Publication
(10) Pub. No.: US 2003/0015481 A1
(43) Pub. Date: Jan. 23, 2003

(54) METHOD AND APPARATUS FOR TREATING/DISINFECTING BALLAST WATER IN SHIPS

(76) Inventor: Ola Magne Eidem, Elnesvagen (NO)

Correspondence Address: CHRISTIAN D. ABEL, POSTBOKS 333 SENTRUM, BERGEN, N-5804, NO

(21) Appl. No.: 09/892,521

(22) Filed: Jun. 28, 2001

(51) Int. Cl. C02F 1/78

(52) U.S. Cl. 210/760; 210/192; 210/199

(57) ABSTRACT

This invention relates to a method and apparatus for ballast water treatment in order to eliminate/strongly reduce the ballast water's content of biological organisms, by injecting ozone gas into the ballast water during loading of ballast water. The inventive apparatus is sufficiently light, small and cheap such that it can relatively easily be implemented in most existing ships as well as new ship designs, and that is able to satisfactory kill the marine organisms in the ballast water, either as a separate system or in combination with conventional ballast water treatment systems.

This invention relates to a method and apparatus for ballast water treatment in order to eliminate/strongly reduce the ballast water's content of biological organisms.

### BACKGROUND

Ships take in a certain amount of water for stability and trim before a voyage. Depending on the degree of load the ship is carrying and ship type in question, the ballast water is necessary for achieving satisfactory stability in open waters. Thus, ballast water is an unavoidable feature of commercial shipping.

Typically, the amount of ballast water the ship is carrying is adjusted according to the amount of cargo the ships takes on at the port/harbour. In the case when the ship needs more ballast water, this is collected beneath the hull of the ship by a pumping system that transfers the harbour water to the ship's ballast tanks, and in the case when less ballast water is required, the pumping system releases some of the ship's ballast water back into the harbour water. Many harbours and ports have shallow waters, and as a consequence, the pumping process will suck in sediments along with the ballast water. An even larger problem is that the ballast water will normally also contain local marine life. Thus vast quantities of ballast water containing sediments and local marine life from the world's ports and harbours are transported across the oceans and discharged in foreign waters. This constitutes a problem since many coastal areas have local salinity and temperature conditions leading to specialised biotopes which is not able to spread out in open waters on their own. Such local biotopes or ecosystems may be adversely affected by introduction to foreign species.

For Australia it has been estimated that 150 million tonnes of ballast water are released from international shipping and additional 34 million tonnes from coastal vessels each year /The Australian Quarantine and Inspection Service, http://www.aqis.gov.au/docs/ballast/bpamphlet.htm/. Similarly, it is estimated that in 1995, approx. 9 million liters of ballast water was released in U.S. ports every hour/James T. Carlton, 1995, Endangered Species Update, Vol. 12/.

The quantities and extent of ballast water disposal results in a serious environmental problem. It is estimated that around 3000 species are carried in ballast water every day. Even though the dark and oxygen poor conditions in the ballast tanks kills some of the ballast water's content of marine life, the survival rate is more than sufficient to create a considerable problem with spreading of marine species throughout the world. It is apparent that the extent of this spreading may have a considerable impact on the biodiversity of local biotas.

Examples of adversely impacts from ballast water spreading of species includes elimination of zooplankton and subsequent collapse in anchovy fishery in the Black Sea due to introduction of Atlantic comb jelly, extermination of shell fish in Tasmania due to introduction of North Pacific sea stars. There are also examples of outbreaks of algae blooms which are harmful for life both in water and on shore. A recent red tide outbreak in New Zealand was so severe that people breathing the sea air became ill, people have died from eating shell fish from Houn River which were contaminated from toxic outbreaks of ballast water introduced dinoflagellates, a cholera epidemic resulted from ballast water carried cacterium released in Mobile Bay Alabama in 1991, etc.

In addition to the biological effect, the spreading of species may obviously have economical consequences such as damaging local fishery stocks, closing fish and shell farms, and even fouling boat hulls and maritime structures. For instance, European zebra mussels were introduced to the Great Lakes in USA during the 1980's and led to billions of dollars of damage due to clogging of water systems for cities, power plants and factories.

Thus there is a strong need for eliminating, or at least strongly reducing, the spreading of marine species carried in ballast water. As a response to the environmental problems with spreading of exotic species carried in ballast water, many countries have introduced regulations for ships carrying ballast water. There are also soon expected strong international regulations given by International Maritime Organisation (IMO) for all commercial shipping which will demand a satisfactory ballast water management valid for all ships operating on the oceans in order to eliminate the problem with spreading of species.

### PRIOR ART

In short the present regulations on ballast water disposal can be summarised as; ballast water management such as take on ballast water in safe areas and/or discharge ballast water to an approved reception facility or disposal area, and open ocean exchange, that is replace the ballast water taken on in coastal areas with deep ocean water.

Ballast Water Management

For obvious reasons, it is not possible for ships to take on ballast water from only safe areas as long as many harbours and ports around the world are far from safe in this respect. Also, the discharge at approved facilities or areas induces severe practical and economical consequences for commercial shipping. Thus the only presently approved method for addressing this problem is open ocean exchange of ballast water.

Open Ocean Exchange of Ballast Water

In principle, open ocean exchange is a very suited method for eliminating or strongly reduce the problem with spreading of marine species, since organisms that are picked up at the port will not survive in the open ocean and organisms picked up in the open ocean do not survive in coastal areas. There are however two major problems associated with open ocean exchange of ballast water.

The ships operating on the oceans today were not designed to exchange their ballast water. Thus in general, the location of intake and outflow pipes and the design of the ballast tanks do not allow for efficient mixing of water and sediments in the ballast tanks, leading to the creation of accumulation zones for sediments in the ballast tanks which gives “refuge zones” where organisms can “hide” from the fresh sea water. The admixture of ballast water in the tanks can be improved by redesigning the ballast water systems, but for ships the costs will probably be prohibitive. Also, there is a general concern that even if a satisfactory admixture is achieved, there will still be sufficient organisms surviving to allow for a successful invasion of the biotope at the ship's destination.

The other problem associated with open ocean exchange is that the emptying and refilling of the ballast tanks in open waters represents a hazard for the ship and crew due to decreased stability of the ship. This method is therefore limited to relatively calm seas and nice weather conditions. Also, the effective exchange rate is only of 70-90%, thus a considerable risk of successful invasion still exists.

There are known two approaches to avoid this stability loss. One is letting ballast water from the open oceans flow through the ballast tanks, by pumping several times the capacity of the tank of water through the tanks and allowing them to overflow through air vents or deck hatches. This approach replaces approximately 95% of the ballast water and 75% of the original plankton and sediments, but the risk of successful invasions do still exist. Also, even though the stability is not in question the integrity of the ship is compromised, due to factors as free water on deck, danger of tank over-pressurisation. Thus this method is also confined to relatively calm seas.

The other method is known as Brazilian dilution and is a variant of the flow-through where fresh water is loaded on top of the ballast tanks through a special deck pipeline, while simultaneously unloading water through the bottom of the tanks. This method improves the exchange rate considerably and eliminates the problem with over-pressurisation and free water on deck. Also the likelihood for an invasion is significantly decreased. But the potential for an invasion does still exist, and the method requires fitting the ships with a new piping system. Further, the method does compromise the ships integrity such that also this method is confined to calm seas.

Thus in summary; the presently approved method of addressing the invasive species introduction problem is open ocean exchange of ballast water, which currently has a too low exchange efficiency and which constitutes a safety hazard for most ships. Because of this, there have been proposed a variety of methods to reduce the risk of invasive species introductions including more efficient and safer ballast exchange methods, ballast water treatment technologies, and ballast management options.

As mentioned, the ballast management option does include severe practical limitations such as design of reception facilities, reconstructing of the ships ballast systems etc., and will therefore be far too costly to be accepted as a satisfactory solution for commercial shipping. This leaves the ballast water treatment technologies either alone or in combination with open ocean exchange techniques as the only acceptable way of addressing the problem.

Ballast Water Treatment Technology

There are known a variety of ballast water treatment technologies including filtration, hydrocyclone treatment, UV-irradiation, heat treatment, chemical treatment, and plasma pulse treatment.

Filtration techniques has the advantage that they may be designed with small dimensions that can readily be fitted into existing ships, and they will remove all larger organisms, most of the zooplankton and some phytoplankton. However small sized organisms such as some phytoplankton and bacteria will not be properly removed.

A hydrocyclone is suited for separating solid entrained particles from a liquid, thus a hydrocyclone located in the ballast water inlet may effectively prevent sediments from entering the ballast tanks. However, the technique will probably not have any significant effect in separating/preventing small marine organisms from entering the ballast tanks, thus this technique must be combined with a treatment for killing small organisms in the water. A such technique is UV-treatment, where the water is irradiated with high doses of UV-radiation to kill the small organisms. This combined technique has been tested by Tech Trade A/S in Norway, and showed satisfactory kill rates for small organisms during operation of high flow rates (which is necessary due to the large volumes involved). Also, the system has small dimensions enabling it to be installed in existing ships, and is considered safe for the ship and its crew. However, the system does not perform well on larger marine organisms, and the costs of the system are expected to be prohibitive.

The concept of heat treatment is to employ the waste heat from the engine of the ship to heat the ballast water up to a temperature of 35-40° C. which is sufficient for killing most larger organisms. The process is considered safe for the ship and the crew onboard. However, the problem with this technique is that a range of pathogenic bacteria and viruses or encysted stages of marine life is not affected by the heat treatment, and the costs are considered high since the ship's cooling water system need to be rebuilt.

The plasma pulse technology can be described as submerging an unit that creates an intense shock wave with steam bubbles and UV-light in the ballast water that kills the organisms. This technique is considered a safety hazard since the shock wave can effect the integrity of the pipe system and ballast tanks of the ship, and would also probably be very noisy.

The chemical treatment of the ballast water involves adding chemicals into the ballast tanks to kill the organisms. The chemicals should be effective in killing a broad range of marine life forms, have a quick decay rate, and degrade to non-toxic compounds. There are presently a variety of compounds being studied, including ozone, glutaraldehyde, periacetic acid, and chlorine. The advantage of chemical treatment is that the technique is established in on-shore facilities and have proven to be effective in killing a broad range of organisms (although, mostly in fresh water systems). The disadvantages are that chemical treatment is considered prohibitively expensive, may pose a safety threat to the crew handling the chemicals, and may pose an environmental hazard by being chemically active on disposal of the ballast water, especially the long term effect of disposal causes concern. In addition, chemical active compounds in question are also known to lead to corrosion in the ship's ballast water system. Thus an international work group, under the name of Pacific Ballast Water Group, concludes that chemical treatment is probably not a viable option.

Ozone treatment of ballast water is studied by Oemcke and van Leeuwen (1998). They fond that ozone treatment was effective for most organisms and constitutes an exception among chemical treatments, since the ozone becomes almost completely consumed such that the method does not produce serious by-products affecting the environment (as other chemical treatment methods tend to do). Thus, ozone treatment gives an environmental acceptable treatment. However, in the case of in-transit treatment during ballasting (pumping) the costs associated with the method was found to be prohibitive (in the order of 2-10 million USD). Also, the treatment is assumed to give an increased risk for corrosion in the ballast tank system, the pumping rate of large bulk carriers constitutes a big problem, the microbial activity in the sediments will cause a locally ineffective disinfection, and that the method does not satisfactorily remove hypnocysts in the ballast water. Thus they found the treatment as insufficient and suggested to combined ozone treatment with heat treatment and/or filtration.

### OBJECTIVE OF THE INVENTION

The main objective of the invention is to provide a method and apparatus for treating ballast water in ships with ozone that is able to eliminate or considerably reduce the above mentioned problems.

It is also an objective of this invention to provide an apparatus for ozone injection that is sufficiently light, small and cheap such that it can relatively easily be implemented in most existing ships as well as new ship designs, and that is able to satisfactory kill the marine organisms in the ballast water, either as a separate system or in combination with conventional ballast water treatment systems.

### BRIEF DESCRIPTION OF THE INVENTION

The objectives of the invention can be obtained by the features and characteristics as set forth in the accompanying claims and the following description of the invention.

The main objective of the invention can be obtained by employing one or several small sized ozone generators connected in series for supplying a satisfactory amount of ozone (O₃) which is to be injected into the ballast water during ballasting, e.g. by a by-pass-line equipped with a venturi injector located in the ballast water supply line of the ship, where the oxygen (O₂) supply to the ozone generators comprises storage tank for liquid oxygen with sufficient storage capacity, and where the ozone supply is adjusted to give a resulting initial ozone concentration in the ballast water of up to 5 mg/l, preferably in the range of 1-4 mg/l, more preferably in the range of 1.5-3.5 mg/l, and most preferably in the range of 2-3 mg/l, measured as total residual oxidant (TRO).

It is estimated that for average sized ballast water systems, the required ozone supply in order to give a final concentration of about 5 mg/l in the ballast water is in the area of 5 kg/hour during loading of the ballast water. Conventional ozone generators with such high capacities will normally weigh at least 5000 kg. Also, conventional oxygen generators capable of delivering sufficient liquid oxygen to such large ozone generators, would weigh at least 2000 kg, be at least 3 m tall and require a power supply capable of delivering more than 40 kW. It is obvious that such a large supply system for ozone constitutes a serious obstacle, both in a spatial and financial sense for existing as well as future ship designs. The international competition in commercial shipping leaves a very restricted room for enhanced costs. This is believed to be one of the strongest obstacles that has prevented the implementation of ozone treatment of ballast water in commercial shipping, and as a consequence, any system for treating ballast water should be as small, light and cheap as possible.

This feature is obtained in this invention by the use of small sized ozone generators connected in series which are supplied with liquid oxygen from a storage battery. This feature give several advantages;

Small sized ozone generators can readily be installed in narrow confinements and/or other hardly accessible spaces in ships. It is preferred to employ small sized ozone generators from the Swedish company Ozone Technology AB, which have an ozone delivery capacity of 1 kg/hour each. These generators weigh only 400 kg each and can be divided into parts of maximum 50 kg during installing. The generators are described in patent EP0835222, which is incorporated in this application by reference. The small size and light weight generators facilitates both the transportation process and reduces the need for eventual restructuring of the ship design during installing of the generators, and will thus give substantial financial savings as compared to installation of the commonly proposed larger ozone generators.

By use of a storage facility for liquid oxygen, e.g. a battery of transportable liquid gas containers, the need for a heavy and costly oxygen generator and associated oxygen compressor that can produce the required oxygen demand in real-time during ballasting is eliminated. The loading operation of ballast water will normally only be performed at departure, eventually also once in open water (open ocean exchange), giving a ballasting rate of no more than twice a week, normally much less than once a week. Thus, since the average loading period lasts for 3-5 hours, there is more than sufficient time between the loading operations to allow a smaller and leaner oxygen generator to operate continuously and build up a sufficiently large oxygen supply to cover the intense demands during ballasting. It is preferred to employ an oxygen generator that has a capacity in the order of producing 10-20 liters of oxygen an hour for average sized ballast systems that requires an ozone insertion in the order of 5 kg/hour during ballasting since such compressors are very cheap and weigh only 50-100 kg. Also, it is preferred that the oxygen storage consists of a battery of transportable liquid gas containers which can contain liquid oxygen at 150-200 bars since such systems can store sufficient amounts of oxygen in very little space. For the average sized system, a battery of 16 containers that occupies a space in the order of 1.5×1.5×1.8 m³ is sufficient.

Another advantage associated with a small and continuously working oxygen generator(s) is that the need for power supply is reduced to the easily manageable 1-2 kW, an energy output that can readily be supplied by most electric power supplies of existing ships.

By using several small and cheap units, the apparatus for treating ballast water according to this invention, becomes very flexible which can be installed into the ballast system of most existing ship designs, and which can easily be implemented in future ship designs, both as a separate treatment system or in combination with other known systems/methods for ballast water treatment.

The use of small units do also give the advantage of making a ballast treatment system that can easily be sized to match any capacity demand ranging from small boats to the largest ships by simply adjusting the number of units that are installed accordingly.

The above given specified amounts of ozone are preferred since corrosion experiments performed by the inventors have unexpectedly shown that the corrosion problems in ballast tanks that have traditionally been associated with the use of ozone, is insignificant changed as long as the TRO-level is kept below 5 mg/l, while the kill rate for most organisms is very satisfactory at these modest addition levels. This is especially the case for small organisms and micro-organisms. In fact, the corrosion in the ballast tank can even be reduced by addition of ozone under certain conditions.

The ozone generator employs oxygen gas at approximately 2 bar. However, in order to obtain a storage system with a very high storage density, it is preferred to employ a system that stores liquid oxygen. Thus, the storage system requires a compressor that compresses the oxygen from the oxygen generator to a pressure of 150-200 bar for filling the gas containers with liquid oxygen, and at least one combined pressure reduction and flow regulation valve that depressurises and regulates the flow rate of the oxygen that exits the oxygen storage and enters the ozone generator(s).

For existing ship designs, it is often not a trivial matter to install any system for treatment of the ballast water since the original design was not intended for such systems. Thus, there is normally little space and the implementation of pumps, generators, injection nozzles, supply lines, etc. may involve complicated and costly reconstruction of the ship design, at least in the areas associated with the engine room and ballast water system. In these cases, there is an absolute advantage to avoid as much reconstruction and voluminous installations as possible. Thus, the apparatus according to the invention as presented above is a preferred embodiment, since it performs satisfactory in most cases and it comprises relatively light and small sized parts that easily can be spaced at distant compartments by simply adjusting the supply lines for the oxygen flow accordingly.

However, for future ship designs where the implementation of ballast water treatment systems can be addressed before constructing the ship, it is envisioned to improve the performance by combining the ozone treatment as given above with other known techniques such as hydrocyclones at the inlet for separating sediments from the water, different kinds of open ocean exchange techniques, filtering, etc. Especially a combination where the ballast water system is equipped with pipelines that allows to perform a ballast water exchange, e.g. the operation known as Brazilian dilution, where the inlet pipe is equipped with a hydrocyclone for separating out sediments and a admixing zone for admixing ozone in the ballast water is expected to give excellent performance since both the Brazilian dilution method and ozone treatment shows kill rates from 90 to 100%. Then the advantages of the promising Brazilian dilution method, relatively safe open ocean exchange of ballast water and excellent kill rate, is combined with the elimination of “refuge zones” for organisms in the sediments and the effective kill rate of ozone treatment. Other ballast water exchange methods, can of course be employed in a similar manner. A such system is expected to have a practically 100% kill rate for all organisms and still be an economically acceptable solution for future designs. Other embodiments with high expectations are a combination of hydrocyclone, filter and ozone treatment, and a combination of hydrocyclone, UV treatment and ozone treatment, but a combination of only hydrocyclone and ozone treatment should give more than acceptable kill rates for most marine organisms. Existing ship designs with sufficient available space and which allows implementation of these combined solutions, are of course included in the invention.

### DESCRIPTION OF THE DRAWINGS

FIG. 1 shows a flow diagram of a preferred embodiment of the invention.

FIG. 2 shows an example of a suitable centrifugal hydrocyclone for use in systems for disinfecting ballast water.

### DETAILED DESCRIPTION OF THE INVENTION

The invention will now be described in greater detail under reference to accompanying drawings and examples showing preferred embodiments and verification tests of the inventive method.

One should be aware of that when ozone is dissolved in saline sea water, it will quickly react (half time 5.3 seconds) with Br- and Cl-ions in the water and form different brominated and chlorinated oxidisers, which becomes the actual effective disinfectants in ozone treated saline water. In addition, some of the added ozone and resulting oxidisers will almost immediately be consumed by suspended matter in the water. Thus it is the actual content of effective oxidisers after the initial demand has been met that is of interest, and this is given as TRO which is defined as the total amount of HOBr/OBr⁻, HOCl/OCl⁻, bromoamines, and chloroamines in the water, but which for simplicity often is measured as the concentration of free Cl₂ in the water. Thus the actual amount of ozone that must be added to the water in order to give the wanted TRO-value becomes a function of the salinity and content of suspended material in the water. In this application, the TRO-level is specified at one minute after addition of the ozone and is continously measured with a probe in the ballast water. Also, the determination of the actual ozone dosages to obtain the specified TRO-level can easily, and probably should be found by experimental verification by a skilled person in each actual case.

### EXAMPLE 1

### A First Preferred Embodiment for Implementation in Existing Ship Designs

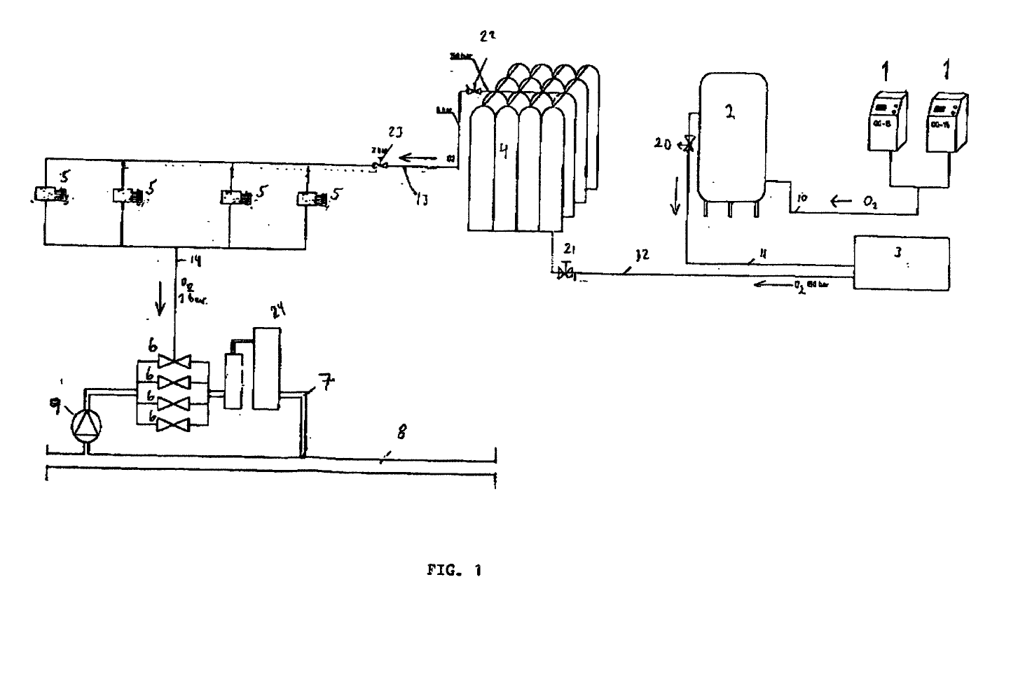

In FIG. 1, a preferred embodiment of the apparatus for implementation on existing ship designs is shown as a flow diagram. In the fig, reference numeral 1 denotes an oxygen generator, 2 is an intermediate oxygen storage vessel, 3 is an oxygen compressor for liquefying the oxygen, 4 is a storage facility for liquid oxygen comprising a battery of transportable gas containers, 5 is an ozone generator, 6 is a venturi injector, 7 is a by-pass of the inlet pipe-line 8 for the ballast water, and 9 is a booster pump for pumping ballast water through pipe 8. As an option, a contact vessel 24, for disposal of excess ozon and/or providing increased reaction-time, is located after the venture injector.

The operation of the preferred embodiment may be divided into two stages, the oxygen storage step and the ballasting step. The oxygen storage step is intended to build up a sufficient supply of oxygen to cover the relatively large demand during the relative short loading of ballast water. During the oxygen storage step, the oxygen storage 4 is more or less empty, thus the oxygen generator 1 is set into action and begins to separate oxygen gas from air supplied from the atmosphere (not shown in the figure). The separated oxygen gas exits the oxygen generators 1 through gas pipe 10 and enters into the intermediate oxygen storage vessel 2, which has closing valve 20 in a closing position. When sufficient oxygen has entered the vessel 2, the oxygen is transported further through gas pipe 11 by opening valve 20 such that the oxygen is transported to and enters compressor 3, where it is compressed and transported through gas pipe 12 at a pressure of at least 150 bar to the oxygen storage facility 4. During this period, closing valve 21 is set to an open position, while the exit pipe 13 from the oxygen storage 4 is closed by setting the pressure regulator 22 in a closing position during the whole storage step. The oxygen storage process will continue until the oxygen storage 4 is full, but can of course be stopped earlier if the demand for oxygen at the next loading of ballast water has been met at lower fill degrees.

After a sufficient oxygen supply has been built up in the oxygen storage 4, the oxygen storage process is stopped by shutting down the oxygen generator(s) 1 and oxygen compressor 3, and closing valve 20 and 21. When the time has come to perform another loading of ballast water, the ballasting step is put into action by activating the ozone generator(s) 5 and the booster pump 9, and by opening pressure regulators 22 and 23 such that the pressure of the oxygen gas flowing in pipe 13 is reduced from 150 to 8 bar by pressure regulator 22, and from 8 bar to the ozone generator's operation pressure of 2 bar by regulator 23. The ozone exiting the ozone generator(s) 5, has a pressure of 1 bar, and enters the venturi injector(s) 6 where it is admixed with the ballast water flowing in the supply line 7. When the ballasting operation is completed, the ozone generator(s) 5 and booster pump 9 are shut down and valve 22 and 23 is closed, and the oxygen storage step is reactivated for another turn.

### EXAMPLE 2

### A Second Preferred Embodiment for Implementation in Existing Ship Designs

In this preferred embodiment, the by-pass line 7 of the inlet pipe for ballast water is omitted and the venturi injectors 6 are placed directly into the supply pipe 8. Otherwise, the embodiment is exactly as given in example 1.

### EXAMPLE 3

### A Third Preferred Embodiment for Implementation in Existing as Well as Future Ship Designs

In this preferred embodiment, the embodiments as given in example 1 or 2 are equipped with a centrifugal hydrocyclone at the inlet pipe 8 up-streams of the venturi injector(s) 6 for separating out sediments from the incoming ballast water. The cyclone employs the g-force vortex separation principle to separate entrained solid matter such as sediments, larger organic life forms, etc. An example of a suitable cyclone is given in FIG. 2. Such cyclones are known from the oil industry and should be placed at the ships intake of ballast water such that the sediments are returned back to the water. When the sediments are eliminated in the ballast tanks, the kill rate from the ozone treatment is expected to be increased, such that this embodiment is expected to give satisfactory kill rates to be accepted for most coming regional and international regulations on disposal of ballast water in coastal areas.

### EXAMPLE 4

### A Fourth Preferred Embodiment for Implementation in Existing as Well as Future Ship Designs

In this preferred embodiment, the combination of hydrocyclone, ballast water exchange and ozone treatment is envisioned, e.g. by equipping the inlet pipe for ballast water with a cyclone at the ship's intake and a venturi injector for ozone downstream of the cyclone. This combination will achieve an optimum disinfection degree if the ballast water that is loaded at the departing harbour is treated with ozone and then subject to an open ocean exchange. In this case, the cyclone will eliminate build up of sediments in the ballast water tanks thus eliminating refugee zones for organisms, the ozone injection will effectively kill almost all micro-organisms and smaller organic life forms, and the saline deep sea water will kill the remaining organisms including larger life forms that were able to survive the ozone treatment. Thus the kill rate of organisms collected at the departing harbour is expected to be very close to 100%. One can also imagine ozone treatment of both the coastal water taken in at departure and the exchange water taken in at open sea, or just ozone treat the exchange water. The latter will however involve a risk for not being able to treat the water at all since open ocean exchange may not be possible to performed during heavy weather.

### EXAMPLE 5

### A Fifth Preferred Embodiment for Implementation in Existing as Well as Future Ship Designs

In this preferred embodiment, the combination of hydrocyclone, filtration and ozone treatment is envisioned. This embodiment is an alternative to the embodiment given in example 4 which is expected to have the same effective kill rates as the combined open ocean exchange and ozone treatment, but which avoids the compromising of the integrity of the ship due to open ocean exchange. In this case the inlet pipe is equipped with a hydrocyclone at the intake, then a filter device that separates out almost 100% of smaller particles of entrained matter and larger organisms, but also a substantial part of the micro-organisms, and finally a injection site for injection of ozone to kill the remaining micro-organisms. This embodiment can probably be implemented in most existing ship designs since it is relatively compact and only induces reconstruction of the inlet pipe of the ballast water system in the ship.

### EXAMPLE 6

### A Sixth Preferred Embodiment for Implementation in Existing as Well as Future Ship Designs

In this preferred embodiment, the combination of hydrocyclone, UV treatment and ozone treatment is envisioned. Applying the UV radiation to the ballast water subsequent to the addition of ozone, is expected to further increase the effect of the ozone treatment, as this process results in the generation of reactive radical intermediates, particularly the hydroxyl radical (OH⁻), that are capable of destroying complex organic substances. With this increased efficiency, the ozone demand will decrease, leading to shorter treatment time and lower costs. The UV radiation unit has small dimensions and the installation in existing ship designs is thus still feasible.

### EXAMPLE 7

### An Alternative Embodiment for Supplying Oxygen

In this preferred embodiment, the possibility of supplying liquid oxygen from external sources in order to fill the oxygen storage, such as on-shore facilities at the departing harbour etc., is envisioned for all embodiments given in examples 1-6, by equipping them with a supply line or other means for loading liquid oxygen. This feature allows ozonation of ballast water at more frequent intervals than the limited capacity of the small sized oxygen generator can cope, thus allowing ozonation of the ballast water in cases when the travel is to short to allow rebuilding the oxygen supply by the on-board oxygen supply system.

Verification of Corrosion Due to Ozone Treatment

The injection of ozone into ballast water is assumed to lead to increased corrosion in the ballast water tanks. Thus the applicant has performed a series of corrosion tests in order to determine the extent the ozone treatment increases the corrosion. These tests were performed by Det Norske Verita AS (DNV), which is an independent Norwegian classification foundation for maritime activity. The corrosion tests were performed by the DNV sub-division “Environmental Advisory Services”. The test on corrosion are given in a confidential test report; Det Norske Veritas, Technical Report No. 2000-3368, “Barber Ship Management. Long term testing of corrosion resulting from ozone treatment of ballast water”, and the entire report is incorporated herein by reference.

The tests were performed on coated and bare steel plates placed above the water surface, partly submerged and fully submerged in a ballast tank that was partly filled/emptied with sea water for 3 different ballast scenarios. The test lasted for 3 months. The tests results are summarised in Table 1. All relevant experimental set up and verification can be found from the reference, and will therefore not be given here. The results for non-coated or bare steel plates are given as estimated corrosion rate per year averaged over the entire surface of the steel plates since they showed a relatively even layer rust. For the coated plates there was only observed a disbonding between the coating and the shop primer on the steel plate in an area around deliberately induced scars in the coating. Corrosion induced scars were visually examined and no significant difference between ozonated and untreated samples could be detected.

TABLE 1
Results from a three-month corrosion test on bare and coated steel
plates placed in a ballast tank partly filled with ozone treated
sea water and with similar test for untreated sea water.

| | | Bare steel plates | Costed steel plates |
|---|---|---|---|
| | | Average thickness | Average disbonding |
| Water | Position | (μm/year) | (mm) |
| Ozone added | Above water line | none* | none* |
| sea water | Partly submerged | 150 | 7.5 mm |
| | Totally sub- | 100 | 8.5 mm |
| | merged | | |
| Untreated | Above water line | none* | none* |
| sea water | Partly submerged | 230 | <3 mm |
| | Totally sub- | 45 | <3 mm |
| | merged | | |

*the results above the water line is not comparable to a realistic corrosion rate since the tanks were not subject to oscillating movements as real tanks would be due to sea movements. Thus the upper part of the tank was dry during the test period.

Note that the above-mentioned numbers are after 3 months. Steady state corrosion rate were not achieved. Test results indicates that the above-mentioned corrosion rates will be lower once steady state is achieved.

The reason for the decreased corrosion rates in the mid level part of the ballast tanks is believed to be that the ozone treatment reduces/removes the corrosive action sustained by the presence of biofilm. Also, the observed rust layers were lighter, denser and more homogeneous than the rust in untreated sea water. This implies that the ozone treatment can lead to a denser corrosion layer that is more protective than the corrosion layers found in untreated sea water. The results given in Table 1 relates to addition TRO-levels below 5 mg Cl₂ per liter water. Above this level, the corrosion rates are expected to increase.

Verification of Kill Rates Due to Ozone Treatment

The applicant has also performed verification tests on the disinfection rates for various addition levels of ozone gas in sea water. The tests are very extensive, thus only the conclusive remarks will be given here. Additional information can be found in test report; Det Norske Veritas, Technical Report No. aaba/00aaaam3, “Barber Ship Management AS. Ballast Water Treatment by Ozonation”, and the entire report is incorporated herein by reference.

The conclusion in the report is;

Ozone is effective for disinfection of most organisms in sea water

The concentration of ozone required for successful treatment will vary depending on the quantity and type of organisms present as well as the quality of the ballast water

The study has revealed that these concentrations can be achieved by standard industrial ozone generators

Ozonation of sea water forms highly corrosive compounds at higher level concentrations

Corrosive compounds decay as a function of ballast water characteristics (presence of organic and other compounds, metal ions and organisms) and will typically only present an elevated level for a period from some hours to 1-2 days following treatment.

Thus in summary, when using a small sized system for producing ozone that exploits the relatively large time intervals between each ozonation and which gives the specified levels of TRO, a new and cheap method for disinfecting ballast water, suitable to be implemented in most existing ship designs is provided. Although given as examples of preferred embodiments, there should be emphasised that there are many alternations and modification of the examples that are obvious for a skilled person and which all belong within the scope of this invention as specified in the appended claims.

1. Method for disinfecting ballast water by injection of ozone gas into the inlet flow of ballast water during loading of ballast water,
characterised in that in order to save space and allowing installation in existing ship designs;
that the ozone is produced in real-time during loading of the ballast water by one or more small sized and light ozone generators,
that the one or more ozone generator(s) is/are supplied with oxygen gas from a small sized high density storage facility for liquid oxygen, and
that the oxygen supply for the ozone generators are produced by one or more oxygen generator with just the necessary capacity to produce sufficient oxygen during the entire rest period between each loading of ballast water.

2. Method according to claim 1,
characterised in that the amount of injected ozone is adjusted to achieve a total residual oxidant (TRO) level in the ballast water at one minute after injection in the range of 0.1-5.0 mg/l.

3. Method according to claim 2,
characterised in that the TRO-level is more preferably in the range of 1-4 mg/l.

4. Method according to claim 2,
characterised in that the TRO-level is more preferably in the range of 1.5-3.5 mg/l.

5. Method according to claim 2,
characterised in that the TRO-level is more preferably in the range of 2-3 mg/l.

6. Method according to any of claim 1 to 5,
characterised in that the ozone gas is injected and admixed into the ballast water in the supply line of ballast water by way of on or more venturi injectors located in the ballast water supply line.

7. Method according to any of claim 1 to 5,
characterised in that the ozone gas is injected and admixed into the ballast water by way of on or more venturi injectors located in a bypass pipe on the supply line of ballast water.

8. Method according to claim 6 or 7,
characterised in that the entrained solid matter, such as sediments, humus, etc., are separated from the ballast water during loading by sending the ballast water through a centrifugal hydrocyclone that is located at the ship's intake of ballast water, or at least upstream for the injectors for ozone admixture in the ballast water supply line.

9. Method for disinfecting ballast water by injection of ozone gas into the inlet flow of ballast water during loading of ballast water,
characterised in that the ballast water that is being loaded into the ballast tanks is first subject
to a separation process for separating out humus, sediments and other relatively coarse solid entrained matter in the ballast water by sending the ballast water through a centrifugal hydrocyclone, then
to a filtration in order to separate out the remaining smaller particles of solid entrained matter, humus, as well as smaller and larger organic life forms, by sending the ballast water through a filtration unit located on the supply line for ballast water downstream of the hydrocyclone, and then
to a disinfection by insertion of ozone gas into the ballast water by way of one or more venturi injectors located in the supply pipe for ballast water.

10. Method according to claim 9,
characterised in that the amount of injected ozone is adjusted to achieve a total residual oxidant (TRO) level in the ballast water at one minute after injection in the range of 0.1-5.0 mg/l.

11. Method according to claim 10,
characterised in that the TRO- level is more preferably in the range of 1-4 mg/l.

12. Method according to claim 10,
characterised in that the TRO-level is more preferably in the range of 1.5-3.5 mg/l.

13. Method according to claim 10,
characterised in that the TRO-level is more preferably in the range of 2-3 Mg/l.

14. Method according to any of claim 9 to 13,
characterised in that the ozone gas is injected and admixed into the ballast water in the supply line of ballast water by way of on or more venturi injectors located in the ballast water supply line.

15. Method according to any of claim 9 to 13,
characterised in that the ozone gas is injected and admixed into the ballast water by way of on or more venturi injectors located in a bypass pipe on the supply line of ballast water.

16. Method for treating ballast water by a combination of a Ballast water exchange process and a disinfecting by injection of ozone gas into the ballast water,
characterised in that the first intake of ballast water which is performed at coastal areas is subject;
to a separation process for separating out humus, sediments and other relatively coarse solid entrained matter in the ballast water by sending the ballast water through a centrifugal hydrocyclone, then
to a disinfection by insertion of ozone gas into the ballast water by way of one or more venturi injectors located in the supply pipe for ballast water, and then
to a replacement by saline deep sea water by an open ocean exchange process known as Ballast water exchange.

17. Method according to claim 16,
characterised in that the amount of injected ozone is adjusted to achieve a total residual oxidant (TRO) level in the ballast water at one minute after injection in the range of 0.1-5.0 mg/l.

18. Method according to claim 17,
characterised in that the TRO-level is more preferably in the range of 1-4 mg/l.

19. Method according to claim 17,
characterised in that the TRO-level is more preferably in the range of 1.5-3.5 mg/l.

20. Method according to claim 17,
characterised in that the TRO-level is more preferably in the range of 2-3 mg/l.

21. Method according to any of claim 16 to 20,
characterised in that the ozone gas is injected and admixed into the ballast water in the supply line of ballast water by way of on or more venturi injectors located in the ballast water supply line.

22. Method according to any of claim 16 to 20,
characterised in that the ozone gas is injected and admixed into the ballast water by way of on or more Venturi injectors located in a bypass pipe on the supply line of ballast water.

23. Method for disinfecting ballast water by injection of ozone gas into the inlet flow of ballast water during loading of ballast water,
characterised in that the ballast water that is being loaded into the ballast tanks is first subject
to a separation process for separating out humus, sediments and other relatively coarse solid entrained matter in the ballast water by sending the ballast water through a centrifugal hydrocyclone, then
to a disinfection by insertion of ozone gas into the ballast water by way of one or more venturi injectors located in the supply pipe for ballast water, and then
to UV radiation of the water in the supply pipe for ballast water by an UV radiating unit located downstream of the venturi injectors for ozone gas.

24. Method according to claim 23,
characterised in that the amount of injected ozone is adjusted to achieve a total residual oxidant (TRO) level in the ballast water at one minute after injection in the range of 0.1-5.0 mg/l.

25. Method according to claim 24,
characterised in that the TRO-level is more preferably in the range of 1-4 mg/l.

26. Method according to claim 24,
characterised in that the TRO-level is more preferably in the range of 1.5-3.5 mg/l.

27. Method according to claim 24,
characterised in that the TRO-level is more preferably in the range of 2-3 mg/l.

28. Method according to any of claim 23 to 27,
characterised in that the ozone gas is injected and admixed into the ballast water in the supply line of ballast water by way of on or more venturi injectors located in the ballast water supply line.

29. Apparatus for performing the treating/disinfecting methods of ballast water as given in any of the preceding claims,
characterised in that it comprises
one or more venturi injectors for injecting ozone gas into the supply line during loading of ballast water, which is in communication with
one or more small sized ozone generator(s) that is/are producing the necessary ozone gas in real time, where the one or more ozone generator(s) is/are supplied with oxygen gas from
a small sized high density storage facility for liquid oxygen, which is equipped with one or more pressure regulating and flow regulating valves in order to regulate the gas flow and pressure of the oxygen flow that is supplied to one or more the ozone generator(s), and which is in communication with
one or more small sized oxygen generator(s) equipped with a compressor for producing liquid oxygen to the high density storage facility for liquid oxygen, and which possess just the necessary capacity to produce sufficient oxygen during the entire rest period between each loading of ballast water.

30. Apparatus according to claim 29,
characterised in that the one or more venturi injector(s) is/are located on a bypass pipe of the ballast water supply pipe.

31. Apparatus according to claim 29,
characterised in that the small sized high density storage facility for liquid oxygen comprises a battery of interconnected transportable gas containers.

32. Apparatus according to claim 29,
characterised in that the one or more small sized ozone generator(s) comprises light generators that has a production capacity of about 1 kg ozone per hour each.

33. Apparatus for performing the treating/disinfecting methods of ballast water as given in any of the preceding claims,
characterised in that it comprises
a centrifugal hydrocyclone located at the intake, or at least upstream for the one or more venturi injector(s) of the supply pipe for ballast water,
one or more venturi injectors for injecting ozone gas into the supply line during loading of ballast water, which is in communication with
one or more small sized ozone generator(s) that is/are producing the necessary ozone gas in real time, where the one or more ozone generator(s) is/are supplied with oxygen gas from
a small sized high density storage facility for liquid oxygen, which is equipped with one or more pressure regulating and flow regulating valves in order to regulate the gas flow and pressure of the oxygen flow that is supplied to one or more the ozone generator(s), and which is in communication with
one or more small sized oxygen generator(s) equipped with a compressor for producing liquid oxygen to the high density storage facility for liquid oxygen, and which possess just the necessary capacity to produce sufficient oxygen during the entire rest period between each loading of ballast water.

34. Apparatus according to claim 33,
characterised in that the one or more venturi injector(s) is/are located on a bypass pipe of the ballast water supply pipe.

35. Apparatus according to claim 33,
characterised in that the small sized high density storage facility for liquid oxygen comprises a battery of interconnected transportable gas containers.

36. Apparatus according to claim 33,
characterised in that the one or more small sized ozone generator(s) comprises light generators that has a production capacity of about 1 kg ozone per hour each.

37. Apparatus for performing the treating/disinfecting methods of ballast water as given in any of the preceding claims,
characterised in that it comprises
a centrifugal hydrocyclone located at the intake of the supply pipe for ballast water,
a filtration unit located downstream of the centrifugal hydrocyclone of the supply pipe for ballast water,
one or more venturi injectors for injecting ozone gas into the supply line during loading of ballast water, which is located downstream of the filtration unit on the supply pipe for ballast water, and which is in communication with
one or more small sized ozone generator(s) that is/are producing the necessary ozone gas in real time, where the one or more ozone generator(s) is/are supplied with oxygen gas from
a small sized high density storage facility for liquid oxygen, which is equipped with one or more pressure regulating and flow regulating valves in order to regulate the gas flow and pressure of the oxygen flow that is supplied to one or more the ozone generator(s), and which is in communication with
one or more small sized oxygen generator(s) equipped with a compressor for producing liquid oxygen to the high density storage facility for liquid oxygen, and which possess just the necessary capacity to produce sufficient oxygen during the entire rest period between each loading of ballast water.

38. Apparatus according to claim 37,
characterised in that the one or more venturi injector(s) is/are located on a bypass pipe of the ballast water supply pipe.

39. Apparatus according to claim 37,
characterised in that the small sized high density storage facility for liquid oxygen comprises a battery of interconnected transportable gas containers.

40. Apparatus according to claim 37,
characterised in that the one or more small sized ozone generator(s) comprises light generators that has a production capacity of about 1 kg ozone per hour each.

41. Apparatus for performing the treating/disinfecting methods of ballast water as given in any of the preceding claims,
characterised in that it comprises
supply pipe and output pipe for ballast water exchange, arranged to facilitate exchange without the ballast tanks being emptied,
a centrifugal hydrocyclone located at the intake of the supply pipe for ballast water,
one or more venturi injectors for injecting ozone gas into the supply line of ballast water during loading of ballast water located on the supply pipe for ballast water, and which is in communication with
one or more small sized ozone generator(s) that is/are producing the necessary ozone gas in real time, where the one or more ozone generator(s) is/are supplied with oxygen gas from
a small sized high density storage facility for liquid oxygen, which is equipped with one or more pressure regulating and flow regulating valves in order to regulate the gas flow and pressure of the oxygen flow that is supplied to one or more the ozone generator(s), and which is in communication with
one or more small sized oxygen generator(s) equipped with a compressor for producing liquid oxygen to the high density storage facility for liquid oxygen, and which possess just the necessary capacity to produce sufficient oxygen during the entire rest period between each loading of ballast water.

42. Apparatus according to claim 41,
characterised in that the one or more venturi injector(s) is/are located on a bypass pipe of the ballast water supply pipe.

43. Apparatus according to claim 41,
characterised in that the small sized high density storage facility for liquid oxygen comprises a battery of interconnected transportable gas containers.

44. Apparatus according to claim 41,
characterised in that the one or more small sized ozone generator(s) comprises light generators that has a production capacity of about 1 kg ozone per hour each.

45. Apparatus for performing the treating/disinfecting methods of ballast water as given in any of the preceding claims,
characterised in that it comprises
a centrifugal hydrocyclone located at the intake of the supply pipe for ballast water,
one or more venturi injectors for injecting ozone gas into the supply line during loading of ballast water, which is in communication with
one or more small sized ozone generator(s) that is/are producing the necessary ozone gas in real time, where the one or more ozone generator(s) is/are supplied with oxygen gas from
a small sized high density storage facility for liquid oxygen, which is equipped with one or more pressure regulating and flow regulating valves in order to regulate the gas flow and pressure of the oxygen flow that is supplied to one or more the ozone generator(s), and which is in communication with
one or more small sized oxygen generator(s) equipped with a compressor for producing liquid oxygen to the high density storage facility for liquid oxygen, and which possess just the necessary capacity to produce sufficient oxygen during the entire rest period between each loading of ballast water,
an UV radiation unit for radiating the ballast water in the supply line during loading of ballast water, which is located downstream of the venturi injectors.

46. Apparatus according to claim 45,
characterised in that the one or more venturi injector(s) is/are located on a bypass pipe of the ballast water supply pipe.

47. Apparatus according to claim 45,
characterized in that the small sized high density storage facility for liquid oxygen comprises a battery of interconnected transportable gas containers.

48. Apparatus according to claim 45,
characterised in that the one or more small sized ozone generator(s) comprises light generators that has a production capacity of about 1 kg ozone per hour each.
